(19) United States
(12) Patent Application Publication
(10) Pub. No.: US 2024/0287294 A1
(43) Pub. Date: Aug. 29, 2024

(54) THERMOPLASTIC ELASTOMER ARTICLES COMPRISING POLAR ELASTOMER AND RUBBER

(71) Applicant: Avient Corporation, Avon Lake, OH (US)

(72) Inventors: Jiren GU, Crystal Lake, IL (US); Hochul JUNG, Algonquin, IL (US); John SWANSON, Lakewood, OH (US)

(73) Assignee: Avient Corporation, Avon Lake, OH (US)

(21) Appl. No.: 18/572,174

(22) PCT Filed: Jun. 29, 2022
(86) PCT No.: PCT/US2022/035505

§ 371 Date: Dec. 19, 2023

Related U.S. Application Data
(60) Provisional application No. 63/216,812, filed on Jun. 30, 2021.

(51) Int. Cl. C08L 9/06; C08J 3/24; C08K 5/5419; C08L 67/00; C08L 75/06; C08L 75/08

(52) U.S. Cl. CPC C08L 9/06; C08J 3/243; C08K 5/5419; C08L 67/00; C08L 75/06; C08L 75/08; C08J 2309/06; C08L 2205/02

(57) ABSTRACT

Embodiments of the present disclosure are directed to thermoplastic elastomer articles including a crosslinked reaction product of polar elastomer, rubber, and silane. The rubber comprises at least one of nitrile butadiene rubber, silicone rubber, ethylene alpha-olefin polyolefin elastomer, and ethylene propylene diene rubber. The rubber is silane grafted and silane crosslinked. The silane crosslinking is at least one of intramolecular silane crosslinking and intermolecular silane crosslinking.

### CLAIM OF PRIORITY

This application claims the benefit of U.S. Provisional Patent Application Ser. No. 63/216,812 bearing Attorney Docket Number 1202105 and filed on Jun. 30, 2021, which is hereby incorporated by reference in its entirety.

### TECHNICAL FIELD

Embodiments of the present disclosure are generally related to thermoplastic elastomer articles, and are specifically related to thermoplastic elastomer articles of polar elastomer and rubber having reduced Shore A hardness and increased oil resistance.

### BACKGROUND

Thermoplastic elastomer articles including polar elastomers may have desirable chemical resistance (e.g., oil resistance). However, these articles may not have the softness and flexibility (e.g., reduced Shore A hardness) necessary for certain applications in the healthcare, automotive, industrial, and electronic fields.

Accordingly, a continual need exists for improved thermoplastic elastomer articles that have reduced Shore A hardness while providing maintained or improved oil resistance for the aforementioned applications.

### SUMMARY

Embodiments of the present disclosure are directed to thermoplastic elastomer articles comprising a crosslinked reaction product of polar elastomer, rubber, and silane, which have reduced Shore A hardness while providing improved oil resistance.

According to one embodiment, a thermoplastic elastomer article is provided. The thermoplastic elastomer article comprises the crosslinked reaction product of polar elastomer, rubber, and silane. The rubber comprises at least one of nitrile butadiene rubber, silicone rubber, ethylene alpha-olefin polyolefin elastomer, and ethylene propylene diene rubber. The rubber is silane grafted and silane crosslinked. The silane crosslinking is at least one of intramolecular silane crosslinking and intermolecular silane crosslinking.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of thermoplastic elastomer articles, specifically thermoplastic elastomer article comprising the crosslinked reaction product of polar elastomer, rubber, and silane. The rubber comprises at least one of nitrile butadiene rubber, silicone rubber, ethylene alpha-olefin polyolefin elastomer, and ethylene propylene diene rubber. The rubber is silane grafted and silane crosslinked. The silane crosslinking is at least one of intramolecular silane crosslinking and intermolecular silane crosslinking.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the crosslinked reaction product that comprises the thermoplastic elastomer article, unless otherwise noted. For simplicity purposes, “wt %” will be referred to throughout as the amount in the thermoplastic elastomer article.

The term “melt flow rate,” as described herein, refers to the ability of a material's melt to flow under pressure as measured according to ASTM D1238 at the given temperature and given weight.

The term “density,” as described herein, refers to the mass per unit volume of a material as measured according to ASTM D792 at 23° C.

The term “specific gravity,” as described herein, refers to the ratio of the density of a material to the density of water as measured according to ASTM D792 at 23° C.

The term “Mooney viscosity,” as described herein, refers to the viscosity reached after a rotor rotates for a given time interval at the specified temperature as measured according to ASTM D1646.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The term “Shore A hardness,” as described herein, refers to the hardness of a material as measured according to ASTM D2240.

The term “silane grafted,” as described herein, refers to the nitrile butadiene rubber, the silicone rubber, the ethylene alpha-olefin polyolefin elastomer, or ethylene propylene diene rubber having a silane side chain connected to the polymer main chain. The grafted silane allow the nitrile butadiene rubber, the silicone rubber, the ethylene alpha-olefin polyolefin elastomer, or ethylene propylene diene rubber to intramolecular silane crosslink or intermolecular silane crosslink.

The term “intramolecular silane crosslinking,” as described herein, refers to silane crosslinking that occurs when the nitrile butadiene rubber, the silicone rubber, the ethylene alpha-olefin polyolefin elastomer, or ethylene propylene diene rubber crosslinks with itself.

The term “intermolecular silane crosslinking,” as described herein, refers to silane crosslinking that occurs when the nitrile butadiene rubber, the silicone rubber, the ethylene alpha-olefin polyolefin elastomer, or the ethylene propylene diene rubber crosslinks with another of the nitrile butadiene rubber, the silicone rubber, the ethylene alpha-olefin polyolefin elastomer, or the ethylene propylene diene rubber.

The term “ethylene propylene diene rubber,” as described herein, may be used interchangeably with “ethylene propylene diene polymer.”

The term “copolymer,” as described herein, refers to a polymer formed when two or more monomers are linked in the same chain.

The term “polyolefin elastomer,” as described herein, refers to a low crystalline (i.e., less than or equal to 25% crystalline) blend including a thermoplastic domain, an amorphous elastomer or rubber domain, and optionally a filler.

As discussed hereinabove, thermoplastic elastomer articles including polar elastomers may have desirable chemical resistance (e.g., oil resistance). However, these articles may not have the softness and flexibility (e.g., reduced Shore A hardness) necessary for certain applications in the healthcare, automotive, industrial and electronic fields.

Disclosed herein are thermoplastic elastomer articles, which mitigate the aforementioned problems. Specifically, the thermoplastic elastomer articles disclosed herein comprise a crosslinked reaction product of polar elastomer, rubber, and silane, which results in an article having reduced Shore A hardness and improved oil resistance. The rubber comprises at least one of nitrile butadiene rubber, silicone rubber, ethylene alpha-olefin polyolefin elastomer, and ethylene propylene diene rubber. The rubber is silane grafted and silane crosslinked. The silane crosslinking is at least one of intramolecular silane crosslinking and intermolecular silane crosslinking. The silane crosslinked rubber produces a thermoplastic elastomer article having reduced Shore A hardness. Additionally, the combination of the polar elastomer and the silane crosslinked rubber also provides increased oil resistance.

The thermoplastic elastomer articles disclosed herein may generally be described as the crosslinked reaction product of polar elastomer, rubber, and silane.

### Polar Elastomer

As described herein, polar elastomer, in combination with silane crosslinked rubber, imparts reduced Shore A hardness to the thermoplastic elastomer article.

In embodiments, the polar elastomer is included in amounts greater than or equal to 40 wt % such that such that the thermoplastic elastomer article has a desired melt viscosity. In embodiments, the amount of polar elastomer may be limited (e.g., less than or equal to 85 wt %) such that the thermoplastic elastomer article has a reduced Shore A hardness. In embodiments, the amount of the polar elastomer in the thermoplastic elastomer article may be greater than or equal to 30 wt %, greater than or equal to 35 wt %, greater than or equal to 40 wt %, greater than or equal to 45 wt %, or even greater than or equal to 48 wt %. In embodiments, the amount of the polar elastomer in the thermoplastic elastomer article may be less than or equal to 85 wt %, less than or equal to 80 wt %, less than or equal to 75 wt %, less than or equal to 70 wt %, or even less than or equal to 67 wt %. In embodiments, the amount of the polar elastomer in the thermoplastic article may be from 30 wt % to 85 wt %, from 30 wt % to 80 wt %, from 30 wt % to 75 wt %, from 30 wt % to 70 wt %, from 30 wt % to 67 wt %, from 35 wt % to 85 wt %, from 35 wt % to 80 wt %, from 35 wt % to 75 wt %, from 35 wt % to 70 wt %, from 35 wt % to 67 wt %, from 40 wt % to 85 wt %, from 40 wt % to 80 wt %, from 40 wt % to 75 wt %, from 40 wt % to 70 wt %, from 40 wt % to 67 wt %, from 45 wt % to 85 wt %, from 45 wt % to 80 wt %, from 45 wt % to 75 wt %, from 45 wt % to 70 wt %, from 45 wt % to 67 wt %, from 48 wt % to 85 wt %, from 48 wt % to 80 wt %, from 48 wt % to 75 wt %, from 48 wt % to 70 wt %, or even from 48 wt % to 67 wt %, or any and all sub-ranges formed from any of these endpoints.

Various polar elastomers are considered suitable for the present thermoplastic elastomer articles. In embodiments, the polar elastomer may comprise thermoplastic polyurethane, thermoplastic copolyester, or a combination thereof. In embodiments, the thermoplastic polyurethane may comprise ether thermoplastic polyurethane, ester thermoplastic polyurethane, or a combination thereof.

In embodiments, the polar elastomer may comprise a Shore A hardness greater than or equal to 60, greater than or equal to 70, greater than or equal to 75, or even greater than or equal to 80. In embodiments, the polar elastomer may comprise a Shore A hardness less than or equal to 95 or even less than or equal to 90. In embodiments, the polar elastomer may comprise a Shore A hardness from 60 to 95, from 60 to 90, from 70 to 95, from 70 to 90, from 75 to 95, from 75 to 90, from 80 to 95, or even from 80 to 90, or any and all sub-ranges formed from any of these endpoints.

In embodiments, the polar elastomer may comprise a density greater than or equal to 1.05 g/cm3 or even greater than or equal to 1.10 g/cm³. In embodiments, the polar elastomer may comprise a density less than or equal to 1.25 g/cm3 or even less than or equal to 1.20 g/cm³. In embodiments, the polar elastomer may comprise a density from 1.05 g/cm3 to 1.25 g/cm³, from 1.05 g/cm3 to 1.20 g/cm³, from 1.10 g/cm3 to 1.25 g/cm³, or even from 1.10 g/cm3 to 1.20 g/cm³, or any and all sub-ranges formed from any of these endpoints.

In embodiments, the polar elastomer may comprise a tensile strength at break greater than or equal to 35 MPa or even greater than or equal to 40 MPA. In embodiments, the polar elastomer may comprise a tensile strength at break less than or equal to 55 MPa or even less than or equal to 50 MPa. In embodiments, the polar elastomer may comprise a tensile strength at break from 35 MPa to 55 MPa, from 35 MPa to 50 MPa, from 40 MPa to 55 MPa, or even from 40 MPa to 50 MPa, or any and all sub-ranges formed from any of these endpoints.

In embodiments, the polar elastomer may comprise a tensile elongation at break greater than or equal to 400% or even greater than or equal to 500%. In embodiments, the polar elastomer may comprise a tensile elongation at break less than or equal to 800% or even less than or equal to 700%. In embodiments, the polar elastomer may comprise a tensile elongation at break from 400% to 800%, from 400% to 700%, from 500% to 800%, or even from 500% to 700%, or any and all sub-ranges formed from any of these endpoints.

Suitable commercial embodiments of the ether thermoplastic polyurethane are available under the IROGRAN brand from Huntsman, such as grade A85P 4394 UV. Similarly, the ester thermoplastic polyurethane may be avilable under the AVALON brand from Huntsman, such as grade 85ABU. Similarly, the thermoplastic copolyester may be available under the SKYPEL brand from SK Chemicals, such as grade G140D. Table 1 shows certain properties of IROGRAN A85P 4394 UV, AVALON 85ABU, and SKYPEL G140D.

TABLE 1

| | IROGRAN A85P | AVALON | SKYPEL |
|---|---|---|---|
| | 4394 UV | 85ABU | G140D |
| Shore A hardness | 85 | 85 | — |
| Density (g/cm³) | 1.12 | 1.20 | 1.21 |
| Tensile strength | 45 | 50 | 43 |
| at break (MPa) | | | |
| Tensile elongation | 650 | 600 | 500 |
| at break (%) | | | |

### Rubber

As described herein, silane crosslinked rubber imparts reduced Shore A hardness to the thermoplastic elastomer article and, in combination with the polar elastomer, provides increased oil resistance.

In embodiments, the rubber is included in amounts greater than or equal to 25 wt % such that the thermoplastic elastomer has a reduced Shore A hardness and increased oil resistance. In embodiments, the amount of rubber may be limited (e.g., less than or equal to 65 wt %) such that the thermoplastic elastomer article has a desired melt viscosity. In embodiments, the amount of rubber in the thermoplastic elastomer article may be greater than or equal to 25 wt %, greater than or equal to 30 wt %, or even greater than or equal to 35 wt %. In embodiments, the amount of rubber in the thermoplastic elastomer article may be less than or equal to 70 wt %, less than or equal to 65 wt %, less than or equal to 60 wt %, or even less than or equal to 55 wt %. In embodiments, the amount of rubber in the thermoplastic elastomer article may be from 25 wt % to 70 wt %, from 25 wt % to 65 wt %, from 25 wt % to 60 wt %, from 25 wt % to 55 wt %, from 30 wt % to 70 wt %, from 30 wt % to 65 wt %, from 30 wt % to 60 wt %, from 30 wt % to 55 wt %, from 35 wt % to 70 wt %, from 35 wt % to 65 wt %, from 35 wt % to 60 wt %, or even from 35 wt % to 55 wt %, or any and all sub-ranges formed from any of these endpoints.

Various rubbers are considered suitable for the present thermoplastic elastomer articles. In embodiments, the rubber may comprise at least one of nitrile butadiene rubber, silicone rubber, ethylene alpha-olefin polyolefin elastomer, and ethylene propylene diene rubber. For example, in embodiments, the rubber may comprise nitrile butadiene rubber. In other embodiments, the rubber may comprise silicone rubber. In another embodiment, the rubber may comprise silicone rubber and ethylene alpha-olefin polyolefin elastomer.

### Nitrile Butadiene Rubber

In embodiments, the nitrile butadiene rubber may comprise a density greater than or equal to 0.95 g/cm³ or even greater than or equal to 1.00 g/cm³. In embodiments, the nitrile butadiene rubber may comprise a density less than or equal to 1.15 g/cm³ or even less than or equal to 1.10 g/cm³. In embodiments, the nitrile butadiene rubber may comprise a density from 0.95 g/cm³ to 1.15 g/cm³, from 0.95 g/cm³ to 1.10 g/cm³, from 1.00 g/cm³ to 1.15 g/cm³, or even from 1.00 g/cm³ to 1.10 g/cm³, or any and all sub-ranges formed from any of these endpoints.

In embodiments, the nitrile butadiene rubber may comprise a Mooney viscosity (M+L, 100° C.) greater than or equal to 35 or even greater than or equal to 45. In embodiments, the nitrile butadiene rubber may comprise a Mooney viscosity (M+L, 100° C.) less than or equal to 65 or even less than or equal to 55. In embodiments, the nitrile butadiene rubber may comprise a Mooney viscosity (M+L, 100° C.) from 35 to 65, from 35 to 55, from 45 to 65, or even from 45 to 55, or any and all sub-ranges formed from any of these endpoints.

In embodiments, the nitrile butadiene rubber may comprise an acrylonitrile content greater than or equal to 20 wt %, greater than or equal to 25 wt % or even greater than or equal to 30 wt %. In embodiments, the nitrile butadiene rubber may comprise an acrylonitrile content less than or equal to 50 wt %, less than or equal to 45 wt %, less than or equal to 40 wt % or even less or equal to 35 wt %. In embodiments, the nitrile butadiene rubber may comprise an acrylonitrile content from 20 wt % to 50 wt %, from 20 wt % to 45 wt %, from 20 wt % to 40 wt %, from 20 wt % to 35 wt %, from 25 wt % to 50 wt %, from 25 wt % to 45 wt %, from 25 wt % to 40 wt %, from 25 wt % to 35 wt %, from 30 wt % to 50 wt %, from 30 wt % to 45 wt %, from 30 wt % to 40 wt %, or even from 30 wt % to 35 wt %, or any and all sub-ranges formed from any of these endpoints.

Suitable commercial embodiments of the nitrile butadiene rubber are available under the CHEMIGUM brand from Synthomer, such as grade P615DS. Table 2 shows certain properties of CHEMIGUM P615DS.

TABLE 2

| | CHEMIGUM P615DS |
|---|---|
| Density (g/cm³) | 1.04 |
| Mooney viscosity (ML 1 + 4, 100° C.) | 50 |
| acrylonitrile content (%) | 33 |

33

### Silicone Rubber

In addition to imparting reduced Shore A hardness and improved oil resistance, silicone rubber may impart a silky feeling (e.g., low coefficient of friction) to the thermoplastic elastomer article.

In embodiments, the silicone rubber may comprise at least one vinyl functional group. In embodiments, the vinyl functional group is selected for peroxide curing. In embodiments, the silicone rubber may comprise high consistency silicone rubber. In embodiments, the silicone rubber may comprise polydimethylsiloxane.

Suitable commercial embodiments of the silicone rubber are available under the GENIOPLAST PELLET brand from Wacker Chemie AG, such as grade S.

### Ethylene Alpha-Olefin Polyolefin Elastomer

The ethylene alpha-olefin polyolefin elastomer is the polymerized reaction product of ethylene and C₃-C₁₂ olefins. For example, in embodiments, the ethylene alpha-olefin polyolefin elastomer may comprise ethylene-octene copolymer, ethylene-hextene copolymer, ethylene-butene copolymer, or a combination thereof.

In embodiments, the ethylene alpha-olefin polyolefin elastomer may comprise a melt flow rate (190° C./2.16 kg) greater than or equal to 0.1 g/10 min or even greater than or equal to 0.25 g/10 min. In embodiments, the ethylene alpha-olefin polyolefin elastomer may comprise a melt flow rate (190° C./2.16 kg) less than or equal to 3 g/10 min or even less than or equal to 1 g/10 min. In embodiments, the ethylene alpha-olefin polyolefin elastomer may comprise a melt flow rate (190° C./2.16 kg) from 0.1 g/10 min to 3 g/10 min, from 0.1 g/10 min to 1 g/10 min, from 0.25 g/10 min to 3 g/10 min, or even from 0.25 g/10 min to 1 g/10 min, or any and all sub-ranges formed from any of these endpoints.

In embodiments, the ethylene alpha-olefin polyolefin elastomer may comprise a density greater than or equal to 0.80 g/cm³ or even greater than or equal to 0.85 g/cm³. In embodiments, the ethylene alpha-olefin polyolefin elastomer may comprise a density less than or equal to 0.95 g/cm³ or even less than or equal to 0.90 g/cm³. In embodiments, the ethylene alpha-olefin polyolefin elastomer may comprise a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the ethylene alpha-olefin polyolefin elastomer may comprise a tensile strength at break greater than or equal to 1 MPa or even greater than or equal to 2 MPa. In embodiments, the ethylene alpha-olefin polyolefin elastomer may comprise a tensile strength at break less than or equal to 10 MPa or even less than or equal to 5 MPa. In embodiments, the ethylene alpha-olefin polyolefin elastomer may comprise a tensile strength at break from 1 MPa to 10 MPa, from 1 MPa to 5 MPa, from 2 MPa to 10 MPa, or even from 2 MPa to 5 MPa, or any and all sub-ranges formed from any of these endpoints.

In embodiments, the ethylene alpha-olefin polyolefin elastomer may comprise a tensile elongation at break greater than or equal to 750% or even greater than or equal to 1000%. In embodiments, the ethylene alpha-olefin polyolefin elastomer may comprise a tensile elongation at break less than or equal to 1750% or even less than or equal to 1500%. In embodiments, the ethylene alpha-olefin polyolefin elastomer may comprise a tensile elongation at break from 750% to 1750%, from 750% to 1500%, from 1000% to 1750%, or even from 1000% to 1500%, or any and all sub-ranges formed from any of these endpoints.

In embodiments, the ethylene alpha-olefin polyolefin elastomer may comprise a Shore A hardness greater than or equal to 40 or even greater than or equal to 45. In embodiments, the ethylene alpha-olefin polyolefin elastomer may comprise a Shore A hardness less than or equal to 60 MPa or even less than or equal to 65 MPa. In embodiments, the ethylene alpha-olefin polyolefin elastomer may comprise a Shore A hardness from 40 to 60, from 40 to 55, from 45 to 60, or even from 45 to 55, or any and all sub-ranges formed from any of these endpoints.

Suitable commercial embodiments of the ethylene alpha-olefin polyolefin elastomer are available under the ENGAGE brand from Dow Chemical Company, such as grade XLT 8677. Table 3 shows certain properties of ENGAGE XLT 8677.

TABLE 3

| | ENGAGE XLT 8677 |
|---|---|
| Melt flow rate (190° C./2.16 kg) (g/10 min) | 0.50 |
| Density (g/cm³) | 0.870 |
| Mooney viscosity (ML 1 + 4) | 45 (121° C.) |
| Tensile strength at break (MPa) | 3.00 |
| Tensile elongation at break (%) | >1000% |
| Shore A Hardness | 51 |

### Ethylene Propylene Diene Rubber

The ethylene propylene diene rubber is the polymerized reaction product of ethylene, propylene, and diene. The diene monomer may comprise one or more of ethylidene norbornene, dicyclopentadiene, and vinyl norbornene.

In embodiments, the ethylene propylene diene rubber may comprise a density greater than or equal to 0.80 g/cm³ or even greater than or equal to 0.85 g/cm³. In embodiments, the ethylene propylene diene rubber may comprise a density less than or equal to 0.95 g/cm³ or even less than or equal to 0.90 g/cm³. In embodiments, the ethylene propylene diene rubber may comprise a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

Suitable commercial embodiments of the ethylene propylene diene rubber are available under the NORDEL brand from Dow Chemical Company, such as grade IP 4785HM. Table 4 shows certain properties of NORDEL IP 4785HM.

TABLE 4

| | NORDEL IP 4785HM |
|---|---|
| Density (g/cm³) | 0.880 |
| Mooney viscosity (ML 1 + 4) | 85 (125° C.) |

### Silane

As stated hereinabove, the rubber is silane grafted and silane crosslinked. The silane crosslinked rubber produces a thermoplastic elastomer article having reduced Shore A hardness and improved oil resistance

Various silanes are considered suitable for the present thermoplastic elastomer articles. In embodiments, the silane may comprise vinyl trialkoxysilane. For example, in embodiments, the silane may comprise vinyl trimethoxysilane, vinyl triethoxysilane, or a combination thereof.

In embodiments, the silane is included in amounts greater than or equal to 0.3 wt % such that the rubber is silane grafted and silane crosslinked to produce a thermoplastic elastomer article having reduced Shore A hardness and increased oil resistance. In embodiments, the amount of silane in the thermoplastic elastomer article may be greater than or equal to 0.3 wt %, greater than or equal to 0.5 wt %, greater than or equal to 1 wt %, greater than or equal to 1.5 wt %, or even greater than or equal to 2 wt %. In embodiments, the amount of silane in the thermoplastic elastomer article may be less than or equal to 3.5 wt %, less than or equal to 3 wt %, or even less than or equal to 2.5 wt %. In embodiments, the amount of silane in thermoplastic elastomer article may be from 0.3 wt % to 3.5 wt %, from 0.3 wt % to 3 wt %, from 0.3 wt % to 2.5 wt %, from 0.5 wt % to 3.5 wt %, from 0.5 wt % to 3 wt %, from 0.5 wt % to 2.5 wt %, from 1.5 wt % to 3.5 wt %, from 1.5 wt % to 3 wt %, from 1.5 wt % to 2.5 wt %, from 2 wt % to 3.5 wt %, from 2 wt % to 3 wt %, or even from 2 wt % to 2.5 wt %, or any and all sub-ranges formed from any of these endpoints.

In embodiments, the silane may have a specific gravity greater than or equal to 0.9 or even greater than or equal to 0.95. In embodiments, the silane may have a specific gravity less than or equal to 1.05 or even less than or equal to 1. In embodiments, the silane may have a specific gravity from 0.9 to 1.05, from 0.9 to 1, from 0.95 to 1.05, or even from 0.95 to 1, or any and all sub-ranges formed from any of these endpoints.

In embodiments, the silane may have a boiling point greater than or equal to 75° C. or even greater than or equal to 100° C. In embodiments, the silane may have a boiling point less than or equal to 150° C. or even less than or equal to 125° C. In embodiments, the silane may have a boiling point from 75° C. to 150° C., from 75° C. to 125° C., from 100° C. to 150° C., or even from 100° C. to 125° C., or any and all sub-ranges formed from any of these endpoints.

Suitable commercial embodiments of the silane are available under the SILQUEST brand from Momentive, such as grade A-171.

In embodiments, the silane may be included in a solution comprising organic peroxide such that the silane is better dispersed within the rubber, leading to improved silane grafting and silane crosslinking. In embodiments, the organic peroxide may comprise dicumyl peroxide. In embodiments, the amount of organic peroxide in the thermoplastic elastomer article may be greater than or equal to 0.05 wt % or even greater than or equal to 0.1 wt %. In embodiments, the amount of organic peroxide in the thermoplastic elastomer article may be less than or equal to 0.5 wt % or even less than or equal to 0.25 wt %. In embodiments, the amount of organic peroxide in the thermoplastic elastomer article may be from 0.05 wt % to 0.5 wt %, from 0.05 wt % to 0.25 wt %, from 0.1 wt % to 0.5 wt %, or even from 0.1 wt % to 0.25 wt %, or any and all sub-ranges formed from any of these endpoints.

In embodiments, the organic peroxide may have a density greater than or equal to 1.00 g/cm³ or even greater than or equal to 1.05 g/cm³. In embodiments, the organic peroxide may have a density less than or equal to 1.20 g/cm³ or even less than or equal to 1.15 g/cm³. In embodiments, the organic peroxide may have a density from 1.00 g/cm³ to 1.2 g/cm³, from 1 g/cm³ to 1.15 g/cm³, from 1.05 g/cm³ to 1.2 g/cm³, or even from 1.05 g/cm³ to 1.15 g/cm³, or any and all sub-ranges formed from any of these endpoints.

In embodiments, the organic peroxide may have a boiling point greater than or equal to 75° C. or even greater than or equal to 100° C. In embodiments, the organic peroxide may have a boiling point less than or equal to 150° C. or even less than or equal to 125° C. In embodiments, the organic peroxide may have a boiling point from 75° C. to 150° C., from 75° C. to 125° C., from 100° C. to 150° C., or even from 100° C. to 125° C., or any and all sub-ranges formed from any of these endpoints. In embodiments, the organic peroxide may decompose at a temperature lower than the boiling point of the organic peroxide.

Suitable commercial embodiments of the organic peroxide are available under the PERKADOX brand from AkzoNobel, such as grade BC-FF.

### Thermoplastic Elastomer Article

As described herein, The silane crosslinked rubber produces a thermoplastic elastomer article having reduced Shore A hardness. Moreover, the combination of the polar elastomer and the silane crosslinked rubber also provides increased oil resistance.

In embodiments, the rubber is silane grafted and silane crosslinked. In embodiments, the silane crosslinking is at least one of intramolecular silane crosslinking and intermolecular silane crosslinking. For example, in embodiments, silicone rubber may be silane crosslinked to the ethylene alpha-olefin polyolefin elastomer.

In embodiments, the thermoplastic elastomer article may have a Shore A hardness greater than or equal to 50, greater than or equal to 55, greater than or equal to 60, greater than or equal to 65, or even greater than or equal to 70. In embodiments, the thermoplastic elastomer may have a Shore A hardness less than or equal to 90, less than or equal to 85, or even less than or equal to 80. In embodiments, the thermoplastic elastomer article may have a Shore A hardness from 50 to 90, from 50 to 85, from 50 to 80, from 55 to 90, from 55 to 85, from 55 to 80, from 60 to 90, from 60 to 85, from 60 to 80, from 65 to 90, from 65 to 85, from 65 to 80, from 70 to 90, from 70 to 85, or even from 70 to 80, or any and all sub-ranges formed from any of these endpoints.

In embodiments, the thermoplastic elastomer article may have a tensile strength at break greater than or equal to 3 MPa, greater than or equal to 4 MPa, greater than or equal to 5 MPa, or even greater than or equal to 6 MPa. In embodiments, the thermoplastic elastomer article may have a tensile strength at break less than or equal to 15 MPa, less than or equal to 12 MPa, or even less than or equal to 10 MPa. In embodiments, the thermoplastic elastomer article may have a tensile strength at break from 3 MPa to 15 MPa, from 3 MPa to 12 MPa, from 3 MPa to 10 MPa, from 4 MPa to 15 MPa, from 4 MPa to 12 MPa, from 4 MPa to 10 MPa, from 5 MPa to 15 MPa, from 5 MPa to 12 MPa, from 5 MPa to 10 MPa, from 6 MPa to 15 MPa, from 6 MPa to 12 MPa, or even from 6 MPa to 10 MPa, or any and all sub-ranges formed from any of these endpoints.

In embodiments, the thermoplastic elastomer article may have a tensile elongation at break greater than or equal to 250%, greater than or equal to 300%, or even greater than or equal to 350%. In embodiments, the thermoplastic elastomer article may have a tensile elongation at break less than or equal to 700%, less than or equal to 650%, less than or equal to 600%, or even less than or equal to 550%. In embodiments, the thermoplastic elastomer article may have a tensile elongation at break from 250% to 700%, from 250% to 650%, from 250% to 600%, from 250% to 550%, from 300% to 700%, from 300% to 650%, from 300% to 600%, from 300% to 550%, from 350% to 700%, from 350% to 650%, from 350% to 600%, or even from 350% to 550%, or any and all sub-ranges formed from any of these endpoints.

In embodiments, the thermoplastic elastomer article comprises the crosslinked reaction product of polar elastomer, nitrile butadiene rubber, and silane. In embodiments, the thermoplastic elastomer article comprises the crosslinked reaction product of polar elastomer, silicone rubber, and silane. In embodiments, the thermoplastic elastomer article comprises the crosslinked reaction product of polar elastomer, silicone rubber, ethylene alpha-olefin polyolefin elastomer, and silane.

As exemplified in the Examples section below, the thermoplastic elastomer articles described herein comprising a crosslinked reaction product of polar elastomer, rubber, and silane have reduced Shore A Hardness and improved oil resistance.

### Additive

In embodiments, the thermoplastic elastomer article may further comprise an additive. In embodiments, the additive may comprise adhesion promoters; biocides; anti-fogging agents; anti-static agents; blowing and foaming agents; bonding agents and bonding polymers; dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

### Processing

In embodiments, the thermoplastic elastomer article described herein may be made with a batch process or continuous process.

In embodiments, the components of the thermoplastic elastomer article, including the polar elastomer and the rubber, may be added to an extruder (27 MM Leistriz Twin Extruder (L/D 52)) and blended. In embodiments, silane is added to the blend such that the rubber is silane grafted. In embodiments, the blending (e.g., in the barrel of the extruder) may be carried out at a temperature from 150° C. to 220° C.

Blending (also known as compounding) devices are well known to those skilled in the art and generally include feed means, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

In embodiments, the shaped, silane-grafted blend may be cured such that the rubber is silane crosslinked.

### Examples

Table 5 below shows sources of ingredients used to form the thermoplastic elastomer articles of Comparative Examples C1 and C2 and Examples E1-E5.

TABLE 5

| Ingredients | Brand | Source |
|---|---|---|
| nitrile butadiene rubber | CHEMIGUM P615DS | Synthomer |
| ether thermoplastic polyurethane | IROGRAN A85P | Huntsman |
| (ether TPU) | 4394 UV | |
| ester thermoplastic polyurethane | AVALON 85ABU | Hunstman |
| (ester TPU) | | |
| thermoplastic copolyester | SKYPEL G140D | SK Chemicals |
| vinyltrimethoxy silane | SILQUEST A-171 | Momentive |
| dicumyl peroxide | PERKADOX BC-FF | AkzoNobel |

Table 6 below shows the formulations used to form and the certain properties of Comparative Examples C1 and C2 and Examples E1 to E5. To prepare the comparative and exemplary thermoplastic elastomer plaques, the components of the formulations listed in Table 6 were added into a 27 MM Leistriz Twin Extruder (L/D 52) and blended at a barrel temperature of 193° C. and a rate of 5 rotations per second. The mixed formulation was extruded at a speed of 5 g/s. The blended formulation was injection molded (i.e., shaped) to form a plaque.

To measure the “oil immersion weight increase” listed in Table 6, the plaque having a diameter of 39 mm and a thickness of 3 mm was weighed and then immersed in IRM 903 oil for 3 days at 125° C. After immersion, the plaque was weighed and the weight percentage increase was calculated.

TABLE 6

| | Example | | | | | |
|---|---|---|---|---|---|---|
| | C1 | | E1 | | E2 | |
| Ingredient | Parts | Wt. % | Parts | Wt. % | Parts | Wt. % |
| CHEMIGUM P615DS | 0 | 0 | 35.00 | 34.13 | 50.00 | 48.75 |
| IROGRAN A85P 4394 UV | 100.00 | 97.50 | 65.00 | 63.38 | 50.00 | 48.75 |
| SILQUEST A-171 | 2.38 | 2.32 | 2.38 | 2.32 | 2.38 | 2.32 |
| PERKADOX BC-FF | 0.18 | 0.18 | 0.18 | 0.18 | 0.18 | 0.18 |
| TOTAL | 102.56 | 100.00 | 102.56 | 100.00 | 102.56 | 100.00 |
| Hardness (Shore A) | 84 | | 75 | | 70 | |
| Tensile strength | 19.4 | | 9.4 | | 6.1 | |
| at break (MPa) | | | | | | |
| Tensile elongation | 570 | | 600 | | 490 | |
| at break (%) | | | | | | |
| Oil immersion weight | 28 | | 19 | | 19 | |
| increase (125° C./3 days, | | | | | | |
| %) | | | | | | |

TABLE 6

| | Example | | | |
|---|---|---|---|---|
| | E3 | | E4 | |
| Ingredient | Parts | Wt. % | Parts | Wt. % |
| CHEMIGUM P615DS | 40.00 | 39.00 | 50.00 | 48.75 |
| AVALON 85ABU | 60.00 | 58.50 | 50.00 | 48.75 |
| SILQUEST A-171 | 2.38 | 2.32 | 2.38 | 2.32 |
| PERKADOX BC-FF | 0.18 | 0.18 | 0.18 | 0.18 |
| TOTAL | 102.56 | 100.00 | 102.56 | 100.00 |
| Hardness (Shore A) | 71 | | 67 | |
| Tensile strength | 9.9 | | 6.4 | |
| at break (MPa) | | | | |
| Tensile elongation | 570 | | 510 | |
| at break (%) | | | | |
| Oil immersion weight | 13 | | 15 | |
| increase (125° C./ | | | | |
| 3 days, %) | | | | |
| | Example | | | |
| | C2 | | E5 | |
| Ingredient | Parts | Wt. % | Parts | Wt. % |
| CHEMIGUM P615DS | 0 | 0 | 40.00 | 39.00 |
| SKYPEL G140D | 100.00 | 97.50 | 60.00 | 58.50 |
| SILQUEST A-171 | 2.38 | 2.32 | 2.38 | 2.32 |
| PERKADOX BC-FF | 0.18 | 0.18 | 0.18 | 0.18 |
| TOTAL | 102.56 | 100.00 | 102.56 | 100.00 |
| Hardness (Shore A) | 94 | | 87 | |
| Tensile strength | 11.0 | | 8.9 | |
| at break (MPa) | | | | |
| Tensile elongation | 880 | | 320 | |
| at break (%) | | | | |
| Oil immersion weight | 21 | | 18 | |
| increase (125° C./ | | | | |
| 3 days, %) | | | | |

As shown in Table 6, Examples E1-E5, thermoplastic elastomer articles including polar elastomer (IROGRAN A85P 4394 UV, AVALON 85ABU, and SKYPEL G140D, respectively) and nitrile butadiene rubber (CHEMIGUM P615D), showed a reduced oil immersion weight increase as compared to Comparative Examples C1 and C2, thermoplastic elastomer articles including IROGRAN A85P 4394 UV and SKYPEL G140D, respectively, without CHEMIGUM P615D, which had an oil immersion weight increase of 28% and 21%, respectively.

Moreover, Examples E1 and E2, thermoplastic elastomer articles including IROGRAN A85P 4394 UV and CHEMIGUM P615D showed a reduced Shore A hardness as compared to Comparative Example C1, a thermoplastic elastomer article including IROGRAN A85P 4394 UV without CHEMIGUM P615D. Example E5, a thermoplastic article including SKYPEL G140D and CHEMIGUM P615D showed a reduced Shore A hardness as compared to Comparative Example C2, a thermoplastic elastomer article including SKYPEL G140D without CHEMIGUM P615D

As indicated by Comparative Examples C1 and C2 and Examples E1-E5, including nitrile butadiene rubber with polar elastomer results in a thermoplastic elastomer article having improved oil resistance and reduced Shore A hardness as compared to a thermoplastic elastomer article that does not include nitrile butadiene rubber.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A thermoplastic elastomer article comprising a crosslinked reaction product of:
polar elastomer;
rubber, the rubber comprising at least one of nitrile butadiene rubber, silicone rubber, ethylene alpha-olefin polyolefin elastomer, and ethylene propylene diene rubber; and
silane;
wherein the rubber is silane grafted and silane crosslinked, and
wherein the silane crosslinking is at least one of intramolecular silane crosslinking and intermolecular silane crosslinking.

2. The thermoplastic elastomer article of claim 1, wherein the rubber comprises nitrile butadiene rubber.

3. The thermoplastic elastomer article of claim 1, wherein the thermoplastic elastomer article comprises 30 wt % to 85 wt % of the polar elastomer, or 35 wt % to 80 wt % of the polar elastomer, or 40 wt % to 75 wt % of the polar elastomer.

4. The thermoplastic elastomer article of claim 1, wherein the polar elastomer comprises thermoplastic polyurethane, thermoplastic copolyester, or a combination thereof.

5. The thermoplastic elastomer article of claim 4, wherein the thermoplastic polyurethane comprises ether thermoplastic polyurethane, ester thermoplastic polyurethane, or a combination thereof.

6. The thermoplastic elastomer article of claim 1, wherein the thermoplastic elastomer article comprises 25 wt % to 70 wt % of the rubber, or 30 wt % to 65 wt % of the rubber, or 35 wt % to 60 wt % of the rubber.

7. The thermoplastic elastomer article of claim 1, wherein the ethylene alpha-olefin polyolefin elastomer comprises C₃-C₁₂ olefins.

8. The thermoplastic elastomer article of claim 7, wherein the ethylene-alpha olefin copolymer comprises ethylene-octene copolymer, ethylene-hextene copolymer, ethylene-butene copolymer, or a combination thereof.

9. The thermoplastic elastomer article of claim 1, wherein the ethylene propylene diene rubber comprises a functional group, the functional group comprising ethylidene norbornene, dicyclopentadiene, vinyl norbornene, or a combination thereof.

10. The thermoplastic elastomer article of claim 1, wherein the thermoplastic elastomer article comprises 0.3 wt % to 3.5 wt % silane.

11. The thermoplastic elastomer article of claim 1, wherein the silane comprises vinyl trialkoxysilane.

12. The thermoplastic elastomer article of claim 11, wherein the silane comprises vinyl trimethoxysilane, vinyl triethoxysilane, or a combination thereof

13. The thermoplastic elastomer article of claim 1, wherein the silane is included in a solution comprising organic peroxide.

14. The thermoplastic elastomer article of claim 13, wherein the organic peroxide comprises dicumyl peroxide.

15. The thermoplastic elastomer of claim 1, wherein the thermoplastic elastomer article has a Shore A hardness from 50 to 90.

16. A process for making a thermoplastic elastomer article comprising a crosslinked reaction product of polar elastomer, rubber, and silane, the rubber comprising at least one of nitrile butadiene rubber, silicone rubber, ethylene alpha-olefin polyolefin elastomer, and ethylene propylene diene rubber, the process comprising the steps of:
blending the polar elastomer and the rubber;
grafting the blend with silane such that the rubber is silane grafted;
shaping the silane-grafted blend; and
curing the shaped, silane-grafted blend such that the rubber is silane crosslinked.

17. A thermoplastic elastomer article comprising a crosslinked reaction product of:
polar elastomer;
silicone rubber; and
silane;
wherein the silicone rubber is silane grafted and silane crosslinked.

18. A thermoplastic elastomer article comprising a crosslinked reaction product of:
polar elastomer;
silicone rubber;
ethylene alpha-olefin polyolefin elastomer; and
silane;
wherein at least one of the silicone rubber and the ethylene alpha-olefin polyolefin elastomer is silane grafted and silane crosslinked, and
wherein the silane crosslinking is at least one of intramolecular silane crosslinking and intermolecular silane crosslinking.
